(19) United States
(12) Patent Application Publication
(10) Pub. No.: US 2020/0095486 A1
(43) Pub. Date: Mar. 26, 2020

(54) REACTIVE HOT-MELT ADHESIVE COMPOSITION CONTAINING A POLYESTER-POLYURETHANE

(71) Applicant: Lubrizol Advanced Materials, Inc., Cleveland, OH (US)

(72) Inventors: Gonzalo Lowenberg, Barcelona (ES); Barbara M. Galisteo-Almiron, Barcelona (ES); Daniel Salvatella Radresa, Terrassa (ES); Jose Sese Solano, Barcelona (ES)

(21) Appl. No.: 16/483,923

(22) PCT Filed: Feb. 7, 2018
(86) PCT No.: PCT/US2018/017153

§ 371 Date: Aug. 6, 2019

(30) Foreign Application Priority Data
Feb. 9, 2017 (EP) 17382062.2

(51) Int. Cl. C09J 175/06; C08G 18/12; C08G 18/30; C08G 18/42; C08G 18/73; C08G 18/76; C08G 18/75

(52) U.S. Cl. CPC C09J 175/06; C08G 18/12; C08G 18/307; C08G 18/4238; C08G 18/4277; C08G 2250/00; C08G 18/7671; C08G 18/755; C09J 2203/10; C08G 2170/20; C08G 18/73

(57) ABSTRACT

A reactive hot-melt adhesive composition is provided which is the product of a reaction mixture comprising a polyester-polyurethane intermediate, optionally crystalline and/or amorphous polyesters or polyethers, and an excess of isocyanate groups. The inclusion of the polyester-polyurethane intermediate in the reactive hot-melt adhesive composition allows the properties of the adhesive composition to be customized for various applications.

### FIELD OF THE INVENTION

The disclosed technology relates to a reactive hot-melt adhesive composition containing a polyester-polyurethane intermediate material. Inclusion of the polyester-polyurethane material allows customization of the properties of the reactive hot-melt adhesive composition.

### BACKGROUND OF THE INVENTION

Reactive hot-melt adhesives (rHMA) are also known as “moisture curing hot-melt adhesives.” These adhesive materials are generally solids at room temperatures. Following application and melting, they physically bind to a material, not only by cooling and solidifying, but also by chemical reaction of free isocyanate groups with ambient moisture. Moisture curable, reactive hot-melt adhesives typically comprise (i) a crystalline polyester component, (ii) an amorphous polyester or polyether component (either liquid or solid or a mixture thereof), and (iii) an isocyanate component, where the isocyanate is present in amounts sufficient to provide a molar excess of NCO/OH groups.

Reactive hot-melt adhesive compositions act in two phases. The first phase is physical crosslinking where the initial adhesion (also known as green strength) develops as a result of both the cooling process and the crystallization of the soft segments of the polyol component. The second phase is chemical crosslinking. In this phase, the isocyanate groups react with moisture (either ambient or present in the substrate), where the moisture acts to increase the molecular weight of the resulting polymer adhesive. The chemical crosslinking reaction also takes place in two stages. First, the isocyanate groups react with water and produce an amine and dioxide carbonate. Then, the newly formed amine reacts with other isocyanate groups and produces urea. The reaction ends when all the available isocyanate is consumed and produces a polyurea. The fully reacted polymer contains alternating urethane and urea groups. This structure provides the final characteristics of the adhesive composition. The chemically crosslinked adhesive does not re-melt when subject to subsequent heating.

The specific chemical composition of the reactive hot-melt adhesive determines various characteristics of the adhesive, including the initial adhesion (also known as green strength), which is the point at which the adhesive can hold two substrates together in the absence of external force, setting time, which is the time to form a bond without tack, open time, which is the working time to make a bond where the surface still maintains tack, and melt viscosity. Different applications of reactive hot-melt adhesives may require different balances of properties. However, it is not desirable to reformulate an entire hot-melt adhesive composition or components thereof for different applications. Therefore, there exists a need to allow reactive hot-melt adhesive compositions to be customized to exhibit certain characteristics desired for a particular application, without having to completely reformulate the reactive hot-melt composition. The present technology provides a composition and system to address this need.

### SUMMARY OF THE INVENTION

The present invention provides a reactive hot-melt adhesive composition comprising the reaction product of (a) a polyester-polyurethane component comprising the reaction product of (i) a low molecular weight hydroxyl-functional polyester polyol having a number average molecular weight (Mn) of about 4,000 Daltons or lower as measured by assay of terminal functional groups and (ii) a first polyisocyanate component, wherein a ratio of isocyanate groups from the first polyisocyanate to hydroxyl groups from the hydroxyl-functional polyester is less than 1:1 and (b) a second polyisocyanate component. The first and second polyisocyanate components may be the same or different.

The reactive hot-melt adhesive composition of the invention may also further comprise a crystalline polyester component, an amorphous solid polyester component, an amorphous liquid polyester component, or combinations thereof.

In the reactive hot-melt composition of the present invention, the second polyisocyanate component is present in amounts sufficient to provide an excess molar ratio of NCO:OH.

### DETAILED DESCRIPTION OF THE INVENTION

Various preferred features and embodiments will be described below by way of non-limiting illustration.

The present invention provides a reactive hot-melt adhesive composition comprising the reaction product of (a) a polyester-polyurethane component comprising the reaction product of (i) a low molecular weight hydroxyl-functional polyester polyol having a number average molecular weight (Mn) of about 4,000 Daltons or lower measured by assay of terminal functional groups and (ii) a first polyisocyanate component, wherein a ratio of isocyanate groups from the first polyisocyanate to hydroxyl groups from the hydroxyl-functional polyester is less than 1:1 and (b) a second polyisocyanate component. The reactive hot-melt adhesive composition of the invention may also further comprise a crystalline polyester component, an amorphous solid polyester or polyether component, an amorphous liquid polyester or polyether component, or combinations thereof. In the reactive hot-melt composition of the present invention, the second polyisocyanate component is present in amounts sufficient to provide an excess molar ratio of NCO:OH.

### Polyester-Polyurethane Intermediate Component

The polyester-polyurethane intermediate component of the present invention comprises the reaction product of (i) a low molecular weight hydroxyl-functional polyester and (ii) a polyisocyanate component. As used herein to describe the hydroxyl-functional polyester useful for making the polyester-polyurethane intermediate component, the phrase, “low molecular weight,” refers to a number average molecular weight (Mn) of about 4,000 Daltons or lower measured by assay of terminal functional groups. The polyester polyurethane intermediate component has hydroxyl-functionality.

In one embodiment, the polyester-polyurethane intermediate component has the following structure:

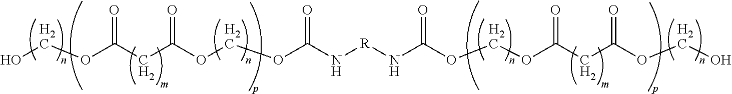

wherein n=0-6, m=2-14, p=3-27, and R is provided by the isocyanate component. In some embodiments, for example, n may be any integer from 0-6, m may be any integer from 2-14, and p may be any integer from 3-27. R may be derived from hexamethylene diisocyanate, methylene dicyclohexyl diisocyanate, isophorone diisocyanate, tolyl diisocyanate, or methylenediphenyl diisocyanate. In some embodiments, R is hexamethylene, methylene dicyclohexyl, isophorone, tolyl, methylenediphenyl, and the like.

Polyisocyanates useful for making the polyester-polyurethane intermediate of the present invention may be selected from any isocyanates known to those skilled in the art. In some embodiments, the first polyisocyanate component includes one or more diisocyanates. Useful polyisocyanates may be selected from aromatic polyisocyanates or aliphatic polyisocyanates or combinations thereof. Examples of useful polyisocyanates include, but are not limited to aromatic diisocyanates such as 4,4′-methylenebis(phenyl isocyanate) (MDI), 3,3′-dimethyl-4,4′-biphenylene diisocyanate (TODI), m-xylene diisocyanate (XDI), phenylene-1,4-diisocyanate, naphthalene-1,5-diisocyanate, 1,5-naphthalene diisocyanate (NDI), and toluene diisocyanate (TDI), as well as aliphatic diisocyanates such as isophorone diisocyanate (IPDI), 1,4-cyclohexyl diisocyanate (CHDI), 1,6-hexamethylene diisocyanate (HDI), decane-1,10-diisocyanate, lysine diisocyanate (LDI), 1,4-butane diisocyanate (BDI), isophorone diisocyanate (PDI), and dicyclohexylmethane-4,4′-diisocyanate (H12MDI). Mixtures of two or more polyisocyanates may be used. In some embodiments, the first polyisocyanate is MDI and/or H12MDI. In some embodiments, the first polyisocyanate comprises or even consists essentially of MDI.

Hydroxyl terminated polyester intermediates useful for making the polyester-polyurethane component of present invention include low molecular weight polyester polyols, wherein the low molecular weight polyester polyols have an Mn of 4,000 Daltons or lower, for example 500 Daltons to 4,000 Daltons, or further for example, 500 Daltons, to 3,000 Daltons, or even 500 Daltons to 2,500 Daltons, or even 500 Daltons to 2,000 Daltons. The hydroxyl-functional polyester components may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ϵ-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. The glycols which are reacted to form a desirable polyester intermediate can be aliphatic, aromatic, or combinations thereof, including any of the glycol described above in the chain extender section, and have a total of from 2 to 20 or from 2 to 12 carbon atoms. Suitable examples include alkylene glycols, such as, ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

The polyol component may also include one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from ϵ-caprolactone and a bifunctional initiator such as diethylene glycol, 1,4-butanediol, or any of the other glycol and/or diol listed herein. In some embodiments, the polycaprolactone polyester polyols are linear polyester diols derived from caprolactone monomers.

Useful examples include CAPA™ 2202A, a 2000 number average molecular weight (Mₙ) linear polyester diol, and CAPA™ 2302A, a 3000 Mₙ linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, hexane diol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has an Mn from 500 to 10,000, or from 500 to 5000, or from 1000 or even 2000 to 4000 or even 3000.

The hydroxyl-functional polyester and polyisocyanate described herein are combined such that the molar ratio of NCO groups from the first polyisocyanate to OH groups from the low molecular weight polyester polyol is less than 1:1, for example, about 0.4:1 to about 0.8:1, further for example, about 0.5:1 to about 0.7:1. The reaction of the hydroxyl-functional polyester with the polyisocyanate increases the molecular weight of the polyester by adding urethane groups into the polyester chain. The polyester-polyurethane intermediate material has hydroxyl functionality. The presence of the urethane groups in the polyester provides the benefits of both a polyester and a polyurethane material to the reactive hot-melt composition with a single component.

The polyester-polyurethane described herein may have an Mn of from about 4,000 Daltons to about 10,000 Daltons, for example, 4,000 Daltons to 8,000 Daltons, or even 4,000 Daltons to 6,000 Daltons as measured by assay of terminal functional groups.

### Polyisocyanates

Polyisocyanates useful as the second polyisocyanate component in the reaction mixture to make the reactive hot-melt adhesive composition may be the same polyisocyanates as those used for making the polyester-polyurethane intermediate or be different polyisocyanates. The polyisocyanates used as the second polyisocyanate component in the present invention may be selected from any isocyanates known to those skilled in the art. In some embodiments, the polyisocyanate component includes one or more diisocyanates. Useful polyisocyanates may be selected from aromatic polyisocyanates or aliphatic polyisocyanates or combinations thereof. Examples of useful polyisocyanates include, but are not limited to aromatic diisocyanates such as 4,4′-methylenebis(phenyl isocyanate) (MDI), m-xylene diisocyanate (XDI), phenylene-1,4-diisocyanate, 3,3′-dimethyl-4,4′-biphenylene diisocyanate (TODI), 1,5-naphthalene diisocyanate (NDI), and toluene diisocyanate (TDI), as well as aliphatic diisocyanates such as isophorone diisocyanate (IPDI), 1,6-hexamethylene diisocyanate (HDI), 1,4-cyclohexyl diisocyanate (CHDI), decane-1,10-diisocyanate, lysine diisocyanate (LDI), 1,4-butane diisocyanate (BDI), isophorone diisocyanate (PDI), and dicyclohexylmethane-4,4′-diisocyanate (H12MDI). Mixtures of two or more polyisocyanates may be used as the second polyisocyanate component. In some embodiments, the second polyisocyanate component is MDI and/or H12MDI. In some embodiments, the second polyisocyanate comprises or even consists essentially of MDI.

### Other Reactive Hot-Melt Components

The reactive hot-melt compositions of the present invention may also comprise one or more crystalline polyol components and one or more amorphous polyol components. The amorphous polyol components may be in solid or liquid form.

Crystalline polyols are typically in solid form at room temperature (e.g. 25° C.). The crystalline polyol may be a polyester polyol. Crystalline polyester polyols may comprise the reaction product of an aliphatic diol having from 2 to 10 methylene groups and an aliphatic diacid having from 2 to 10 methylene groups. Diols useful in forming the crystalline polyester polyol include ethylene glycol, 1,3-propanediol, 1,4-butanediol, 1,5-pentanediol, 1,6-hexanediol, 1,8-octanediol, and 1,10-decanediol. Cycloaliphatic diols such as 1,4-cyclohexanediol and 1,4-cyclohexanedimethanol can also be used. Aliphatic diacids useful in preparing the crystalline polyester polyol include succinic acid, glutaric acid, adipic acid, sebacic acid, 1,12-dodecanedioc acid, dimerized fatty acids, derivatives thereof, and mixtures thereof. Examples of suitable crystalline polyester polyols which can be utilized in reactive hot-melt compositions of the present invention include poly(hexanediol adipate) polyol, poly(butanediol adipate) polyol, poly E-caprolactone polyol, polyhexanediol (dodecanedioic acid) polyol and the like. When employed the crystalline polyols may represent up to about 60% by weight, or up to about 50% by weight, or up to about 40% by weight, or up to about 30% by weight, or up to 20% by weight, or up to 10% by weight, or up to 5% by weight of the reaction mixture to form the reactive hot-melt composition. In some embodiments, the reactive hot-melt reaction mixture is substantially free of crystalline polyester polyol.

The amorphous polyol may comprise a polyether or polyester polyol. Amorphous polyols may be solid or liquid at room temperature. In one embodiment, the amorphous polyol is solid having a T_{g} of greater than 0° C., or even greater than 25° C. as measured by DSC. In another embodiment, the amorphous polyol is liquid having a T_{g} of less than 25° C. as measured by DSC.

In one embodiment, the solid amorphous polyol is a polyester polyol. In one embodiment, the solid amorphous polyester polyol may be the reaction product of a diol and a diacid. Diols useful for making amorphous solid polyester polyols include, but are not limited to, hexanediol, butanediol, neopentyl glycol, ethylene glycol, diethylene glycol, propylene glycol, 2-methylpropanediol, and combinations thereof. Diacids useful for making amorphous solid polyester polyols include but are not limited to adipic acid, isophthalic acid, terephthalic acid, and combinations thereof.

Liquid amorphous polyols may be polyester or polyether polyols. In one embodiment, the liquid amorphous polyol is a polyester polyol, which comprises the reaction product of a diol and a diacid. Diols useful for making the amorphous liquid polyester polyol include, but are not limited to, hexanediol, butanediol, neopentyl glycol, 2-methylpropanediol, and combinations thereof. Diacids useful for making the amorphous liquid polyester polyol include, but are not limited to, adipic acid, isophthalic acid, terephthalic acid, and combinations thereof.

Reactive hot-melt compositions of the present invention comprise the reaction product of (a) a polyester-polyurethane component which comprises the reaction product of (i) a low molecular weight hydroxyl-functional polyester having an Mn of about 4,000 Daltons or lower measured by assay of terminal functional groups and (ii) a first polyisocyanate component, wherein a ratio of isocyanate groups from the first polyisocyanate to hydroxyl groups from the hydroxyl-functional polyester is less than 1:1 and (b) a second polyisocyanate component. In this embodiment, the components, including the polyester-polyurethane component and the second isocyanate component are present in amounts to provide an excess of isocyanate groups to hydroxyl-groups. For example, in this embodiment, the ratio of isocyanate groups from the second polyisocyanate component to hydroxyl-groups from the polyester-polyurethane component or any other polyol components is from 1.5:1 to 2.5:1, for example, 1.75:1 to 2.3:1, and further for example, 2.2:1. Moreover, in this embodiment, the ratio of isocyanate groups from the first polyisocyanate to hydroxyl groups in the low molecular weight hydroxyl functional polyester polyol may be from 0.4:1 to 0.8:1, for example, 0.5:1 to 0.75:1, further for example, 0.5:1 to 0.7:1.

Low molecular weight polyesters and diisocyanate combinations that may be useful for making the polyester-polyurethane component for use in the reactive hot melt of the present invention include, but are not limited to poly (butanediol succinate) and MDI or HDI, poly (butanediol succinate co-sebacate) and MDI or HDI, poly (butanediol sebacate) and MID or HDI, poly (butanediol-co-propanediol) and MDI or HDI, and polycaprolactone and MDI or HDI. Any of these polyester-polyurethanes may be made as fully described herein. Any of these polyester-polyurethanes may be combined with an excess of another isocyanate, such as hexamethylene diisocyanate, methylene dicyclohexyl diisocyanate, isophorone diisocyanate, tolyl diisocyanate, or methylenediphenyl diisocyanate, along with any other components desired to customize the properties of the final reactive hot-melt composition.

The reactive hot-melt compositions described above may further comprise one or more of a crystalline polyester polyol, an amorphous solid polyester polyol, an amorphous solid polyether polyol, an amorphous liquid polyester polyol, and an amorphous liquid polyether polyol.

The reaction mixture to form the hot-melt adhesive composition of the present invention can include the various components, including but not limited to the polyester-polyurethane intermediate, crystalline polyester polyol, amorphous polyester or polyether polyol, and polyisocyanate and combinations thereof, in any amounts as long as the combination provides an NCO:OH ratio of from 1.5:1 to 2.5:1, for example, 1.75:1 to 2.3:1, and further for example, 2.2:1.

The reactive hot-melt composition may also further comprise one or more additives in amounts understood to be effective to those of ordinary skill in the art.

Useful additives include, but are not limited to dyes and pigments, curing catalysts, tackifiers, plasticizers, surfactants, flow agents, flame retardants, silane compounds, dehydrating agents, and the like. Typically, these ingredients are included in amounts of about 5% or less or even about 3% or less, or even about 2% or less.

The reactive hot-melt composition is prepared by mixing the reactants together to form an isocyanate functional polyurethane prepolymer. The reactive hot-melt composition may be prepared in a single step or in multiple steps. In the single step process, the polyester-polyurethane intermediate, and any other polyols (e.g. crystalline polyester, amorphous solid or liquid polyester or polyether) are mixed first and may be dehydrated prior to reaction with the second polyisocyanate. The polyester-polyurethane and other polyols, if present, are cooled and then the second polyisocyanate component is added. The reaction is allowed to progress until completion, when no OH groups are detected, or are present in an amount of about 2 g/100 g of prepolymer or less. In the multiple step process, the polyisocyanate may be reacted separately with the polyester polyurethane and any other polyol components, and the reaction products may be mixed together.

The reactive hot-melt composition is an isocyanate functional polyurethane prepolymer. Because it has reactive isocyanate groups, it is usually protected from moisture during storage.

The reactive hot-melt composition of the present invention is able to be customized to have certain desirable properties. For example, it one preferred embodiment, the reactive hot-melt composition is free of or substantially free of solvents. In one embodiment, the reactive hot-melt composition has a melt viscosity measured by Brookfield Thermosel Viscometer Model RVT DV-I using a number 28 spindle in the range of 4,000 to 60,000 mPa.s at 130° C.

The invention described herein may be better understood with reference to the following non-limiting examples.

### EXAMPLES

Exemplary polyester-polyurethane intermediates according to Examples 1-9 as shown in Table 1.

TABLE 1

| | | Isocyanate in | |
|---|---|---|---|
| | | Polyester- | NCO: |
| Example | Polyester | Polyurethane | OH |
| Comp. A | Poly (hexanediol adipate) | None | — |
| Comp. B | Poly (hexanediol dodecanoate) | None | — |
| Example 1 | Poly (butanediol succinate) | MDI | 0.7 |
| | MW 1000-1200 | | |
| Example 2 | Poly (butanediol succinate-co-sebacate) | MDI | 0.6 |
| | (90:10) Mw 1000-1200 | | |
| Example 3 | Poly (butanediol succinate-co-sebacate) | MDI | 0.5 |
| | (80:20) MW 1800-2200 | | |
| Example 4 | Poly (butanediol succinate) | MDI | 0.5 |
| | MW 1800-2200 | | |
| Example 5 | Poly(butanediol sebacate) | MDI | 0.7 |
| | MW 1600-2000 | | |
| Example 6 | Poly (butanediol-co-propanediol | MDI | 0.5 |
| | (90:10) succinate) MW 1600 | | |
| Example 7 | Poly (butanediol succinate) | HDI | 0.5 |
| | MW 1600 | | |
| Example 8 | Polycaprolactone | MDI | 0.5 |
| | MW 2000 | | |
| Example 9 | Poly (butanediol succinate-co-sebacate) | MDI | 0.7 |
| | (75:25) MW 1000 | | |

Reactive hot-melt adhesive compositions were made using a standard reaction mixture of the following: Crystalline polyester: 29%, Solid Amorphous Polyester: 40%, Liquid Amorphous Polyester: 20%, Polyisocyanate: 11%. The components were combined to have a NCO:OH ratio of 2.2:1. In Comparative Examples A and B, standard crystalline polyester polyols as noted in Table 1 were used in the reaction mixture. In Examples 1-9, the crystalline polyester was replaced with the polyester-polyurethane intermediate of the present invention.

Each reactive-hot melt composition was evaluated to determine the Setting Time, Open Time, Softening Point, and Green Stength. The results are summarized in Table 2. Setting time was measured by heating a sample of the reactive-hot melt composition in an oven (T=140° C.) for 45 minutes. 1 gram of the sample was placed on a first wooden board using a 100 μm extensor rod. The sample was spread to cover a 2.5 cm section at the end of the board. The end of a second wooden board is placed horizontally on the surface of the first wooden board and the boards pressed together until the surfaces of both boards are wet. The boards are turned slightly at 15 second intervals, until the boards will no longer slide against each other. The point at which no sliding occurs is called the “Setting Time.” Open time was measured by placing the sample and a 100 μm extensor rod in an oven at 140° C. for 45 minutes. Using the extensor, a coating line about 20-25 cm long of the sample was placed on the paper. Stops of paper are placed onto the coating every 30 seconds over a 15 minute period. The sample is allowed to dry for 24 hours. Then, the strips of paper are removed from the sample in the reverse order of their application. The open time value is the time of application of the strip of paper that tears first due to the adhesion to the sample. Softening point was measured by UNE-EN1238. Green strength was measured by ASTM D1002.

TABLE 2

| | Free | Setting | Open | Softening | Green Strength | | |
|---|---|---|---|---|---|---|---|
| | NCO | time | time | point R&B | (N/mm) | | |
| Example | (%) | (sec) | (sec) | (° C.) | 1 min | 3 min | 24 h |
| Comp. A | 1.9 | 2400 | 3540 | 67 | NA. | N.A. | N.A. |
| Comp. B | 2.0 | 10 | 900 | 77 | 6.5 | 7.2 | >84 |
| Example 1 | 1.7 | 13 | 1020 | 112 | 7.9 | 7.9 | >83 |
| Example 2 | 1.9 | 49 | >57600 | 93 | 4.3 | 4.8 | >83 |
| Example 3 | 1.9 | 28 | 2100 | 95 | 3.6 | 4.5 | >83 |
| Example 4 | 1.9 | 24 | 850.0 | 114 | 5.6 | 6.0 | >83 |
| Example 5 | 2.0 | 22 | 420 | 69 | 2.7 | 3.1 | >84 |
| Example 6 | 2.0 | 70 | 3300 | 100 | 6.8 | 7.2 | >83 |
| Example 7 | 1.9 | 40 | 600 | 112 | 3.7 | 4.2 | >83 |
| Example 8 | 2 | 110 | >57600 | 60 | 2.2 | 3.0 | >84 |
| Example 9 | 1.9 | 110 | >18000 | 72 | 3.5 | 4 | >83 |

Examples 1-9 illustrate that certain characteristics of a reactive hot-melt adhesive composition can be improved by the inclusion of a polyester-polyurethane intermediate component in accordance with the present invention. In addition, Examples 1-9 illustrate that the characteristics of an adhesive composition can be customized by including a polyester-polyurethane component in accordance with the present invention without changing the basic reactive hot-melt formulation.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A reactive hot-melt adhesive composition comprising the reaction product of:
(A) a polyester-polyurethane intermediate comprising the reaction product of (i) a hydroxyl-functional polyester having a molecular weight of about 4,000 Daltons or lower measured by assay of terminal functional groups and (ii) a first polyisocyanate wherein a ratio of isocyanate groups from the first polyisocyanate to hydroxyl groups from the hydroxyl-functional polyester is about 0.4:1 to about 0.75:1; and
(B) a second polyisocyanate.

2. The reactive hot-melt adhesive composition of claim 1 wherein the hydroxyl-functional polyester polyol comprises the reaction product of a alkylene glycol with a dicarboxylic acid.

3. The reactive hot-melt adhesive composition of claim 2 wherein the dicarboxylic acid is selected from adipic acid, sebacic acid, and succinic acid, and mixtures thereof.

4. The reactive hot-melt adhesive composition of claim 2 the alkylene glycol is selected from 1,2-ethylene glycol, 1,4-butanediol, 1,6-hexane diol and mixtures thereof.

5. The reactive hot-melt adhesive composition of claim 1, wherein the hydroxyl-functional polyester polyol comprises polycaprolactone.

6. The reactive hot-melt adhesive composition of claim 1, further comprising:
a crystalline polyester.

7. The reactive hot-melt adhesive composition of claim 1 further comprising:
an amorphous polyester polyol having a Tg less than 25° C. measured by DSC.

8. The reactive hot-melt adhesive composition of claim 1 further comprising:
an amorphous polyester polyol having a Tg greater than 25° C. measured by DSC.

9. The reactive hot-melt adhesive composition of claim 1 further comprising:
an amorphous polyether polyol.

10. The reactive hot-melt adhesive composition of claim 1 wherein the polyester-polyurethane intermediate has a molecular weight of 8,000 Daltons or less as measured by assay of terminal functional groups.

11. The reactive hot-melt adhesive composition of claim 1, wherein the second polyisocyanate is present in an amount sufficient to provide an NCO:OH ratio of 1.5:1 to 2.5:1.

12. The reactive hot-melt adhesive composition of claim 1, wherein the polyester-polyurethane intermediate having the formula: 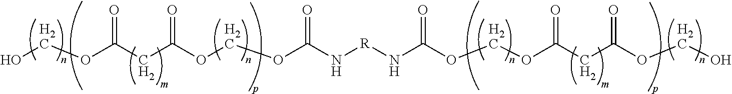
wherein n is 0-6, m is 2-14, p is 3-27, and R is derived from the first isocyanate component.

13. The reactive hot-melt adhesive composition of claim 12, wherein R is derived from hexamethylene diisocyanate, methylene dicyclohexyl diisocyanate , isophorone diisocyanate, tolyl diisocyanate, or methylenediphenyl diisocyanate.

14. A method of making a reactive hot-melt composition comprising:
preparing a polyester polyurethane intermediate by reacting (i) a hydroxyl-functional polyester having a molecular weight of about 4,000 Daltons or lower measured by assay of terminal functional groups and (ii) a first polyisocyanate wherein a ratio of isocyanate groups from the first polyisocyanate to hydroxyl groups from the hydroxyl-functional polyester is about 0.4:1 to about 0.75:1;
preparing an isocyanate functional polyurethane prepolymer from a reaction mixture comprising the polyester polyurethane intermediate and a second polyiscyanate, wherein the second polyisocyanate is present in an amount sufficient to provide an NCO:OH ratio of 1.5:1 to 2.5:1.

15. The method of claim 14 wherein the reaction mixture further comprises a crystalline polyester.

16. The method of claim 14, wherein the reaction mixture further comprises an amorphous polyester polyol having a Tg less than 25° C. measured by DSC.

17. The method of claims 14, wherein the reaction mixture further comprises an amorphous polyester polyol having a Tg greater than 25° C. measured by DSC.

18. The method of claim 14, wherein the reaction mixture further comprises an amorphous polyether polyol.

19. A polyester polyurethane additive for reactive hot-melt adhesive compositions, having the formula 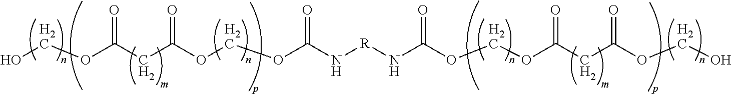
wherein n is any integer from 0-6, m is any integer from 2-14, p is any integer from 3-27, and R is derived from hexamethylene diisocyanate, methylene dicyclohexyl diisocyanate, isophorone diisocyanate, tolyl diisocyanate, or methylenediphenyl diisocyanate.

20. The polyester polyurethane additive of claim 19, wherein the polyester-polyurethane additive has molecular weight of 8,000 Daltons or less as measured by assay of terminal functional groups.

21. The polyester polyurethane intermediate additive of claim 19, wherein the polyester polyurethane additive is formed from the reaction product of (i) a hydroxyl-functional polyester having a molecular weight of about 4,000 Daltons or lower measured by assay of terminal functional groups and (ii) a first polyisocyanate wherein a ratio of isocyanate groups from the first polyisocyanate to hydroxyl groups from the hydroxyl-functional polyester is about 0.4:1 to about 0.75:1.
